(19) United States
(12) Patent Application Publication
(10) Pub. No.: US 2010/0055537 A1
(43) Pub. Date: Mar. 4, 2010

(54) NANOPOROUS POLYMER FILM FOR EFFICIENT MEMBRANE SEPARATOR IN DIRECT METHANOL FUEL CELL

(76) Inventor: Dong June Ahn, Seoul (KR)

Correspondence Address: EDWARDS ANGELL PALMER & DODGE LLP, P.O. BOX 55874, BOSTON, MA, 02205, US

(21) Appl. No.: 12/201,199

(22) Filed: Aug. 29, 2008

(51) Int. Cl. H01M 4/92; H01M 8/04

(52) U.S. Cl. 429/34; 429/40; 429/13

(57) ABSTRACT

The fuel cells disclosed herein include a nanoporous membrane. The nanoporous membrane includes at least one block copolymer and has pores that are sized and configured to restrict the flow of methanol, while allowing hydronium ion (i.e., hydrogen ion) to flow therethrough.

### BACKGROUND

As portable compact electronics such as cell phones, personal digital assistances (PDAs), notebook computers and camcorders perform more functions, they consume more electric power and are required to operate for a longer period of time. In order to satisfy such increasing power demand and to achieve longer continuous operation, batteries for portable compact electronics having a higher energy density are in strong demand.

Currently, lithium secondary batteries are widely used as the main power supply for portable compact electronics. Lithium secondary batteries are expected to have an energy density of about 600 Wh/L by 2006, which is considered the maximum energy density for lithium secondary batteries. As an alternative to lithium secondary batteries, early commercialization of fuel cells having a solid polymer electrolyte membrane is eagerly awaited.

Among fuel cells, direct methanol fuel cells (DMFCs) in which a fuel such as methanol or an aqueous solution having methanol is fed directly into the fuel cell for power generation without converting the fuel into hydrogen are attracting attention. This is because methanol has a very high theoretical energy density and offers advantages of simple system design and easy storage.

A single unit cell contained in a direct methanol fuel cell comprises a membrane electrode assembly (MEA) and separators on both sides of the MEA. The membrane electrode assembly (MEA) includes a solid polymer electrolyte membrane, an anode attached to one surface of the solid polymer electrolyte membrane, and a cathode attached to the other surface of the solid polymer electrolyte membrane. The anode and the cathode each include a catalyst layer and a diffusion layer.

A direct methanol fuel cell generates electricity (power) by feeding a fuel (i.e., methanol or an aqueous solution of methanol) directly into the anode and air to the cathode. In the direct methanol fuel cell, the following reaction occurs.

Anode: CH₃OH+H₂O→CO₂+6H⁺+6e⁻

Cathode: 3/2O₂+6H⁺+6e⁻→3H₂O

Fuel cell: CH₃OH+3/2O₂→CO₂+3H₂O

That is, methanol reacts with water at the anode to produce carbon dioxide, protons and electrons. The protons pass through the electrolyte membrane to reach the cathode. At the cathode, oxygen combines with the protons, and with electrons migrated into the cathode through an external circuit, to produce water.

Direct methanol fuel cells employ, as the electrolyte membrane, a perfluoroalkyl sulfonic acid membrane selected based on proton conductivity, thermal resistance and resistance to oxidation. Electrolyte membranes of this type include a main chain of hydrophobic polytetrafluoroethylene (PTFE) and a side chain of a perfluoro group having hydrophilic sulfonic acid group fixed at the terminal of the perfluoro group. Since methanol has both hydrophilic and hydrophobic parts it is possible for the methanol to pass through the electrolyte membrane. As a result a phenomenon called “methanol crossover” occurs in which methanol fed into the anode pass through the electrolyte membrane to the cathode, without reacting. This methanol crossover reduces the fuel utilization efficiency and the potential of the cathode.

### BRIEF SUMMARY

The fuel cells disclosed herein include a nanoporous membrane. The nanoporous membrane includes at least one block copolymer and has pores that are sized and configured to restrict the flow of methanol, while allowing hydronium ion (i.e., hydrogen ion) to flow therethrough. In one embodiment, the nanoporous membrane includes regular repeating nanopores. The nanopores can have a periodicity in a range from 1 pore/100 nm² to about 20 pores/100 nm². The pore size can be in a range from about 0.5 nm to about 5 nm, alternatively in a range from 0.5 nm to 2 nm, or 0.5 nm to 1 nm. The selective rejection of methanol and simultaneous permeability of hydronium ion allows the nanoporous membrane to be used in a direct methanol fuel cell.

In one embodiment, the polymer is manufactured by combining a first block copolymer and a second block copolymer configured to self assemble into a film with ordered arrangements of the block copolymers on the level of about 0.5 nm to about 5 nm. In one embodiment, the first and second block copolymers can assemble into a structure that includes the nanopores. In an alternative embodiment, the first and second block copolymers form the film and then the second block copolymer is removed from the film to yield the nanopores.

Any block copolymers can be used to make the nanoporous membranes so long as the block copolymers assemble or can be caused to form nanopores that restrict the flow of methanol while allowing the flow of hydrogen ion. For block copolymers that remain in the final material, the block copolymer is typically compatible with a methanol solution within the concentrations suitable for use in direct methanol fuel cells.

The nanoporous membranes are made from block copolymers that can “microphase separate” to form periodic nanostructures. The block copolymers include blocks of a polymeric chain that are immiscible or otherwise incompatible with other blocks of the same or a different block copolymer. The immiscibility or differences in the blocks of polymer cause the phase separation. Because the blocks are covalently bonded to each other, the block copolymers cannot de-mix macroscopically.

In one embodiment, a direct methanol fuel cell is described herein. The direct methanol fuel cell can include an anode including a catalyst suitable for oxidizing methanol and a cathode including a catalyst suitable for reacting hydrogen ion with molecular oxygen. The nanoporous membrane separates the cathode from the anode. The nanoporous membrane includes a polymer film having at least a first block copolymer and having nanopores. The nanopores have a pore diameter that allows cations to flow between the cathode and the anode.

These and other features of the nanoporous membranes and direct methanol fuel cells will become more fully apparent from the following description, drawings, and appended claims, or may be learned by the practice of the claims as set forth hereinafter. The foregoing summary is illustrative only and is not intended to be in any way limiting.

### BRIEF DESCRIPTION OF THE DRAWINGS

FIG. 1 is a diagram of an illustrative embodiment of a single cell of a fuel cell having a nanoporous membrane;

FIG. 2 is a diagram of an illustrative embodiment of a multiple cell fuel cell having a nanoporous membrane;

FIG. 3 is a circuit diagram of an illustrative embodiment of a fuel cell having a nanoporous membrane; and

FIG. 4 is an illustrative embodiment of a personal digital assistant including a fuel cell power source that includes a nanoporous membrane.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The fuel cells disclosed herein include a nanoporous membrane configured for use in direct methanol fuel cells. The nanoporous membrane includes at least one block copolymer and has pores that are sized and configured to restrict the flow of methanol but allow the flow of hydronium ion. As described below, the nanoporous membrane can be manufactured by combining a first block copolymer and a second block copolymer that self assemble into a film with ordered arrangements of the block copolymers. The self assembly typically occurs because of the tendency of hydrophobic and hydrophilic blocks to associate with other blocks of the same type (i.e., hydrophobic blocks associate with other hydrophobic blocks and hydrophilic blocks tend to associate with other hydrophilic blocks). In one embodiment, the first and second block copolymers can assemble into a structure that includes the nanopores. In an alternative embodiment, the first and second block copolymers form a polymeric film and then the second block copolymer is removed from the film to yield nanopores.

Also disclosed are direct methanol fuel cells. The disclosed fuel cells incorporate nanoporous membranes made from block copolymers. The direct methanol fuel cells can include an anode including a catalyst suitable for oxidizing methanol and a cathode including a catalyst suitable for reacting hydrogen ion with molecular oxygen. In the fuel cells, the nanoporous membrane separates the cathode from the anode and allows hydrogen ions to diffuse from the anode to the cathode while prevent methanol from diffusing from the anode to the cathode.

### I. Nanoporous Membranes

The nanoporous membranes are made from block copolymers that can “microphase separate” to form periodic nanostructures. The block copolymers include blocks of the polymeric chain that are immiscible or otherwise incompatible with other blocks of the same and/or a different block copolymer. The immiscibility or differences in the blocks of polymer cause the phase separation. Because the blocks are covalently bonded to each other, they cannot de-mix macroscopically (e.g., like water and oil typically would) and will thus, “micro-phase separate,” thereby forming nanometer-sized structures.

In block copolymers, sufficiently short block lengths lead to nanometer-sized spheres of one block in a matrix of the second (e.g., polymethyl-methacrylate in polystyrene). By using more similar block lengths in the block copolymers, a hexagonally-packed-cylinder geometry can be obtained. Blocks of similar length form layers (also referred to as “lamellae”).

Any block copolymers can be used to make the nanoporous membranes so long as the block copolymers assemble or can be caused to form nanopores that restrict the flow of methanol while allowing the flow of hydrogen ion. For block copolymers that remain in the final material, the block copolymer is typically compatible with a methanol fuel used in direct methanol fuel cells.

In one embodiment, the membranes are made from at least two block copolymers. The at least two block copolymers can typically include a hydrophobic polymer and/or a hydrophilic copolymer. Examples of hydrophobic polymers that can be used in polymer blends include, but are not limited to, polysulfones, polyethersulfones, polyetherimides, polycarbonates, polyimides, polyetheretherketones. Polysulfones, polyethersulfones, polyetherimides and/or polycarbonates can be advantageous in some embodiments. The block copolymers may contain as a hydrophobic polymer block monomer units of those polymers which have been mentioned as the hydrophobic polymers of the polymer blends.

Illustrative examples of hydrophilic polymers include, but are not limited to, polyvinylpyrrolidone, sulfonated polyethersulfones, carboxylated polysulfones, caboxylated polyethersulfones, polyethyloxazolines, poly(ethyleneoxide), poly(ethyleneglycol), polyacrylamides, poly(hydroxyethylmethacrylate), polyvinylalcohols, poly(propyleneoxides), polycarboxylic acids, poly(acrylic acids), poly(methacrylic adds) or poly(acrylic nitrile). Polyvinylpyrrolidone, sulfonated polyethersulfones and/or polyethyloxazolines can be advantageous in some embodiments. The hydrophilic polymer blocks can be composed of monomer units according to the hydrophilic polymers mentioned above as hydrophilic polymers of the polymer blends.

An example of a diblock copolymer that can be used is polystyrene-b-poly(methyl methacrylate) and is made by first polymerizing styrene, and then subsequently polymerizing MMA from the reactive end of the polystyrene chains. In addition to diblock copolymers, any of the foregoing block copolymers can be used to make triblocks, tetrablocks, multiblocks, etc.

The copolymers can be made using various polymerization techniques including, but not limited to, living polymerization techniques, such as atom transfer free radical polymerization (ATRP), reversible addition fragmentation chain transfer (RAFT), ring-opening metathesis polymerization (ROMP), and living cationic or living anionic polymerizations.

As mentioned above, the nanoporous membranes include nanopores. In one embodiment, the nanopores have a pore size (i.e., pore diameter) of about 0.5 nm to 5 nm, alternatively about 0.5 nm to about 1.0 nm. The pore size is selected to minimize flow of dissolved methanol through the pore. The effective size of the methanol can depend on the solution in which the methanol is dissolved. When dissolved in water, the methanol can attract water molecules and/or other dissolved ions through various interaction such as, but not limited to, hydrogen bonding. The bonding of ions in solution increases the effective size of the methanol in solution and increases the pore diameter at which methanol rejection can occur.

The nanopores can be formed in the nanoporous membrane in at least two distinct manners. In one embodiment, the nanopores form in the block copolymer as the block copolymers self assemble. The polymer can be manufactured by combining a first block copolymer and a second block copolymer configured to self assemble into a film with ordered arrangements of nanopores with a diameter in a range from 0.5 nm to about 5 nm. In this first embodiment, the nanopores form in the diblock polymer by virtue of the block copolymers selected and the phase separation induced by the two different block copolymers. Illustrative polymers that can be used include the hydrophobic and/or hydrophilic block copolymers mentioned above.

In a second embodiment, first and second block copolymers form a film that is not porous. After forming the non-porous film all or a portion of one of the block copolymers is removed. The porosity is provided, at least in part by the void or partial void remaining after one of the block copolymers is removed (e.g., by heating).

Example 1 below provides specific examples of methods for making nanoporous membranes. However, the nanoporous membranes that can be used in the fuel cells disclosed herein are not limited to the following example.

### EXAMPLE 1

An amphiphilic coil-rod block copolymer can be made using a coil type poly(2-vinylpyridine) block having a hydrophilic and a rod type poly(n-hexylisocyanate) block having a lipophilic group, as shown in Formula (1) below:

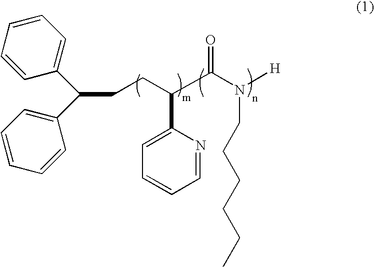

wherein m is a degree of polymerization of the poly(2-vinylpyridine) block; n is a degree of polymerization of the poly(n-hexylisocyanate); and f₂vp, the proportion of the poly(2-vinylpyridine) block in the block copolymer, satisfies 0<f₂vp<1.

A method of preparing the block copolymer represented by Formula 1 includes:
synthesizing a poly(2-vinylpyridine) block by living polymerization using potassium diphenylmethane (KCHPh₂) as initiator;
replacing the potassium counter cation of the poly(2-vinylpyridine) with a sodium ion by adding sodium tetraphenylborate (NaBPh₄) (e.g., using at least an equivalent amount of sodium on a molar basis);
adding n-hexylisocyanate in an amount sufficient to obtain the desired ratio of block copolymers and performing polymerization to obtain a poly(n-hexylisocyanate) block; and
heating the block copolymer to remove at least a portion of one or more block copolymers to yield a nanoprous membrane (e.g., heating above the melting point of the isocyanate block for sufficient time to remove the isocyanate block).

The polymerization reactions can be performed under a high vacuum (10⁻⁶ torr), low temperature (−78 to −100° C.) condition, using a polymerization apparatus that includes ampoules containing an initiator, a monomer, an additive, a reaction terminator, etc. Polymerization can be performed by the typical anion polymerization process. For the polymerization solvent, the commonly used organic solvent for anion polymerization, typically tetrahydrofuran, can be used. Considering that the isocyanate block has relatively weak thermal stability, the poly(n-hexylisocyanate) block may be removed by heat treatment to obtain the nanoporous membrane.

### II. Fuel Cells Incorporating Nanoporous Membranes

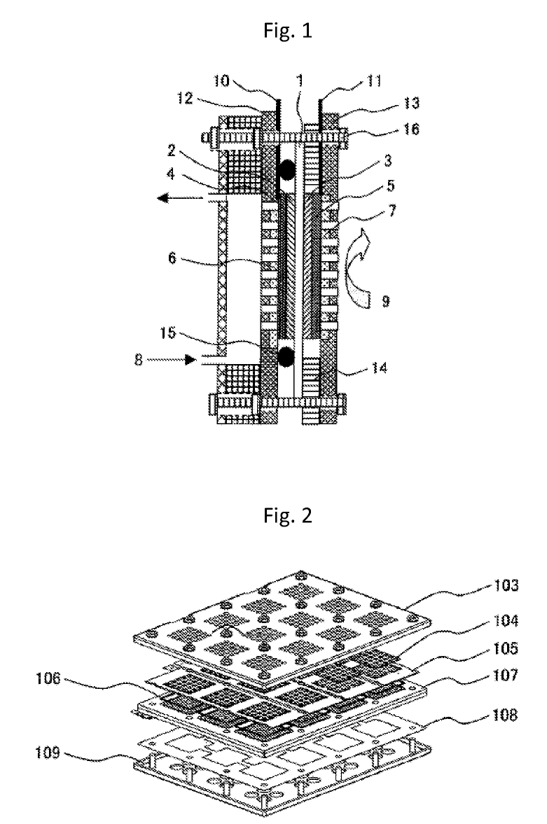

The nanoporous block copolymer membranes are incorporated into a direct methanol fuel cell and can be used to generate power. FIG. 1 illustrates a cross section of a single cell electrode including a nanoporous block copolymer membrane 1, an anode 2, a cathode 3, an anode diffusion layer 4, a cathode diffusion layer 5, an anode current collector 6, a cathode current collector 7, a fuel 8, air 9, an anode terminal 10, a cathode terminal 11, an anode end plate 12, a cathode end plate 13, a gasket 14, an O-ring 15, and bolts and nuts 16. An approximately 20 percent by weight aqueous methanol solution can be used as the fuel and circulated to the anode, while air is typically fed to the cathode to supply molecular oxygen. The methanol concentration in the liquid fuel can be in a range from about 5% to about 100% by weight, alternatively about 10% to about 50% by weight or about 15% to about 30% by weight.

FIG. 2 shows an assemblage of a fuel cell including the electrode assembly incorporating a nanoporous membrane. The fuel cell illustrated in FIG. 2 is assembled by integrating a cathode end plate 103, a cathode current collector 104, a section 105 housing the membrane/electrode assembly (MEA) bearing diffusion layers as shown in FIG. 1, gasket 106, fuel tank 107, packing 108, and an anode end plate 109, which can be secured using bolts and nuts.

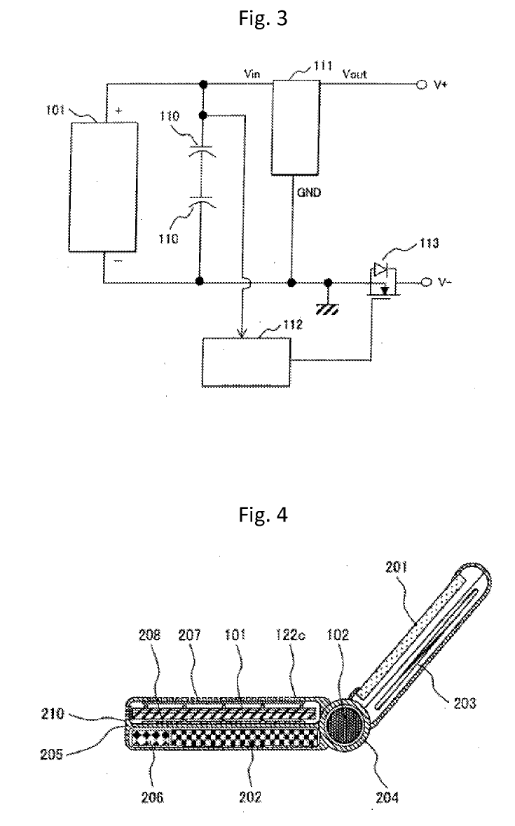

FIG. 3 illustrates a circuit diagram of a power system including a fuel cell assembly identical to the fuel cell assembly shown in FIG. 2 and incorporating a block copolymer membrane. FIG. 3 illustrates fuel cell 101, which includes a block copolymer membrane, a capacitor 110, a power converter 111, for example a DC to DC converter, a load rejection switch 113, and a sensor/controller 112 configured to control ON/OFF of the load rejection switch 113. The power source illustrated in FIG. 3 includes capacitors arrayed in series in two rows. The power source is configured in the following manner: The fuel cell 101 generates electricity, and the capacitor 110 stores the electricity. The sensor/controller 112 determines the electricity in the capacitor and allows the load rejection switch 113 to turn ON when a predetermined quantity of electricity is stored in the capacitor. The electricity is increased to a predetermined voltage by the action of the power converter and is then fed to a source such as an electronic device.

FIG. 4 illustrates a personal digital assistant 210 including the fuel cell power source as described with respect to FIG. 3. In one embodiment, the personal digital assistant has a foldable structure including two units connected through a hinge with cartridge holder 204 serving also as a holder of a fuel cartridge 102. One of the two units includes an antenna 203 and a display unit 201, which can be integrated with a touch-sensitive panel input device. The other unit includes the fuel cell 101, a motherboard 202, and a lithium ion secondary battery 206.

The motherboard 202 includes electronic elements and electronic circuits such as processors, volatile and nonvolatile memories, an electric power controller, a hybrid controller for the fuel cell and the secondary battery, and a fuel monitor. In this example, an auxiliary power source for the fuel cell is a lithium ion secondary battery 206. The auxiliary power source can also be but is not limited to, for example, a nickel hydrogen cell or an electric double layer capacitor.

The section housing the power source is partitioned by a partitioning plate 205 into a lower part and an upper part. The lower part houses the motherboard 202 and the lithium ion secondary battery 206, and the upper part houses the fuel cell power source 101. The upper and side walls of the cabinet have slits 122c for diffusing air and fuel exhaust gas. An air filter 207 is arranged on the surface of the slits 122c in the cabinet and a water-absorptive quick-drying material 208 is arranged on surface of the partitioning plate 205.

While the fuel cell assembly has been shown incorporated into a PDA device in the particular embodiment illustrated in FIG. 4, those skilled in the art will recognize that fuel cell assembly can be incorporated into any type of PDA, and any type of device or unit configured to received a power supply.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A membrane for use in a direct methanol fuel cell, comprising:
a polymer film including a first block copolymer and a plurality of nanopores, wherein polymer film is configured to restrict the flow of hydrated methanol molecules and allow the flow of hydronium ions therethrough.

2. A membrane for use in a direct methanol fuel cell as in claim 1, wherein the first block copolymer includes polystyrene groups.

3. A membrane for use in a direct methanol fuel cell as in claim 2, wherein the polymer film includes a second block copolymer including polyvinylpyridine groups.

4. A membrane for use in a direct methanol fuel cell as in claim 1, wherein the nanopores have a regular repeating pattern.

5. A membrane for use in a direct methanol fuel cell as in claim 1, wherein the nanopores have a periodicity in a range from 1 pore/100 nm² to about 20 pores/100 nm².

6. A membrane for use in a direct methanol fuel cell as in claim 1, wherein a nanopore size is in a range from about 0.5 nm to about 5 nm.

7. A direct methanol fuel cell, comprising:
an anode adapted to oxidize methanol;
a cathode adapted to react hydrogen ion with molecular oxygen; and
a polymer film separating the cathode from the anode,
wherein the polymer film includes a first block copolymer and a plurality of nanopores, and the polymer film allows cations to flow between the cathode and the anode.

8. A direct methanol fuel cell as in claim 7, wherein the polymer-film further includes a second block copolymer.

9. A direct methanol fuel cell as in claim 9, wherein the first block copolymer includes polystyrene groups and the second block copolymer included polyvinylpyridine groups.

10. A direct methanol fuel cell as in claim 7, wherein the plurality of nanopores have a regular repeating pattern.

11. A direct methanol fuel cell as in claim 7, wherein the plurality of nanopores have a periodicity in a range from 1 pore/100 nm² to about 20 pores/100 nm².

12. A direct methanol fuel cell as in claim 7, wherein the plurality of nanopore size is in a range from about 0.5 nm to about 5 nm.

13. A direct methanol fuel cell as in claim 7, wherein the anode includes a first catalyst having platinum supported on a carbon support.

14. A direct methanol fuel cell as in claim 7, wherein the cathode includes a second catalyst having platinum supported on a carbon support.

15. A method for generating electrical power in a fuel cell, comprising:
providing a fuel cell including a cathode and an anode separated by a polymer membrane, wherein the polymer membrane includes a first block copolymer and a second block copolymer, the first and second block copolymers being arranged to provide pores in the polymer membrane allowing the flow of cations between the cathode and the anode;
supplying a methanol fuel to the cathode and oxygen to the anode; and
oxidizing the methanol.

16. A method as in claim 15, wherein the methanol fuel is an aqueous solution containing methanol with a concentration greater than 5.0 mol/L.

17. A method as in claim 15, wherein the first block copolymer includes polystyrene groups and the second block copolymer included polyvinylpyridine groups.

18. A method as in claim 15, wherein the nanopores have a regular repeating pattern.

19. A method as in claim 15, wherein the nanopores have a periodicity in a range from 1 pore/100 nm² to about 20 pores/100 nm².

20. A method as in claim 15, wherein the nanopore size is in a range from about 0.5 nm to about 5 nm.

21. A method as in claim 15, wherein the anode includes a first catalyst having platinum supported on a carbon support.

22. A method as in claim 15, wherein the cathode includes a second catalyst having platinum supported on a carbon support.
